(19) United States
(12) Patent Application Publication
(10) Pub. No.: US 2006/0254620 A1
(43) Pub. Date: Nov. 16, 2006

(54) Process for cleaning asphalt tank cars

(75) Inventors: Gilbert Clark Olson, Evanston, WY (US); Tom Schulthess, Kemmerer, WY (US)

Correspondence Address: WOOD, PHILLIPS, KATZ, CLARK & MORTIMER, 500 W. MADISON STREET, SUITE 3800, CHICAGO, IL, 60661, US

(73) Assignee: Union Tank Car Company

(21) Appl. No.: 11/128,442

(22) Filed: May 13, 2005

(51) Int. Cl. B08B 7/00; B08B 9/00; B08B 5/04

(52) U.S. Cl. 134/22.1; 134/6; 134/21

(57) ABSTRACT

A method of removing residual asphalt from an asphalt transport tank car after substantially unloading the transported asphalt, including the steps of (1) chilling the interior of the tank car to make the residual asphalt brittle, and (2) chipping the brittle residual asphalt from the interior of the tank car. The tank car may be chilled by pumping cooled air into the tank and/or circulating cool liquid through the tank car coils. The tank may be chilled to about 40° F. or below. Chipping may be accomplished by pneumatic chisels or chippers.

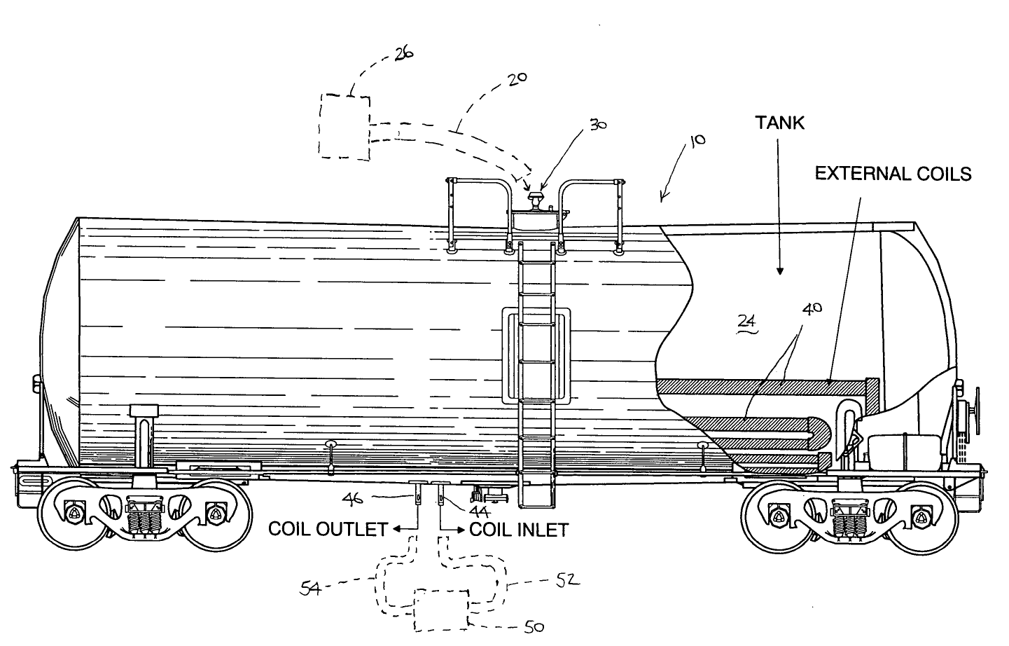

### CROSS REFERENCE TO RELATED APPLICATION(S)

Not applicable.

### STATEMENT REGARDING FEDERALLY SPONSORED RESEARCH OR DEVELOPMENT

Not applicable.

### REFERENCE TO A MICROFICHE APPENDIX

Not applicable.

### TECHNICAL FIELD

The present invention is directed toward tank cars for transporting asphalt, and particularly toward cleaning of such tank cars.

### BACKGROUND OF THE INVENTION AND TECHNICAL PROBLEMS POSED BY THE PRIOR ART

Asphalt is a petroleum byproduct containing volatile materials which is often used in large quantities (e.g., for paving surfaces such as roads and parking lots), and for a wide variety of uses (e.g., roofing, water-proofing, shingles, roll-roofing, roofing felt, pipe coating, protective undercoating, battery cases, tires and floor tile. Understandably, since such materials are produced in large quantities at a relatively few refineries but are used in many different locations, it is necessary to transport such quantities of such materials from the refineries to virtually any location for use.

The asphalt will typically be in a fluid state so that it may be most easily handled, such as being pumped into a tank car for transport in large quantities. Further, desirable fluid characteristics may require that the asphalt be heated to higher than ambient temperatures. Accordingly, tank cars for this purpose often have coils in which steam or other heated fluid (liquid or gas) may be circulated to heat the asphalt when unloading of the asphalt from the car is desired.

Rail transportation is particularly well suited for efficient transport of asphalt, in that it allows large quantities of material to be transported from central locations (e.g., refineries) to regional nodes for unloading and further transport (e.g., via trailer trucks) to sites where the asphalt is needed. However, it should be appreciated that after transporting asphalt in large tank cars and then unloading the asphalt from the cars, a significant residue of asphalt may remain on the walls of the tank cars. It is desirable to remove such asphalt from the walls, both to eliminate build up which may otherwise effectively reduce the tank car capacity for subsequent tank car loads and to prevent such build up from subsequently mixing with different asphalt compositions and potentially negatively affecting the desired compositions of later loads (e.g., the residual asphalt will have a low amount of volatiles, such that when mixed with a load as a result of heating during unloading, the effective percentage of volatiles in the mix may be undesirably reduced.

A number of methods have been heretofore used to clean residual asphalt from tank cars, none of which are particularly economical or fast. Moreover, all are labor intensive and involve tasks which are unpleasant which many workers do not want to do. For example, vapors from hot asphaltic materials are combustible and can be ignited when mixed with the right amount of air, with the flash point depending upon the type and grade of material. In addition to the fire danger, those vapors may be unhealthy to workers. It has been determined that coal tar pitch volatiles (which include asphalt) are carcinogenic when there is prolonged exposure above 0.2 mg/m³, and health standards have been established (with a permissible exposure limit [PEL] and a threshold limit value [TVL] of 0.2 mg/m³ for an eight hour exposure). Further, asphalt may cause inflammation or dermatitis in some individuals. As a result, it is not only necessary to wait to ensure that undesirable vapor levels have left the car before entering to clean it (thereby making the tank car unusable not only while being cleaned but while waiting to be safe to be cleaned), but the workers are understandably wary about spending more than the minimum amount of time necessary to complete the job in such an environment. Even those workers who diligently undertake such cleaning tasks will naturally be disposed toward completing the unpleasant task as soon as possible, and therefore may not accomplish the task as well as desired.

According to one cleaning method which has been used, the tank car is first visually inspected to ensure that it is essentially empty but for the residue (e.g., only one inch or less of the commodity is left). If it is empty, the bottom valve to the car is opened, and a steam hose is inserted through, and secured in, the manway of the car and steam is pumped into the car to heat the residue. A steam hose may also be attached to the heating coil inlet valve of the car to further assist in heating. Such heating is typically done for a number of hours (e.g., a minimum of 4 hours).

In one variation of this method, the tank car is then flushed with cold water (e.g., with a rotary jet, if available, for a minimum of five hours). Thereafter, if a film and residue is left on the inside of the car, it is washed with a detergent solution and water (e.g., for a minimum of three hours), and the solution is then ejected or drained for recycling. A worker then enters the car to inspect for sludge, rust and/or scale and, if any is present, the worker removes it by scrapping or brushing. If necessary, the interior of the car is then dried thoroughly (e.g., by using an air mover or wiping with rags). Of course, the worker may also require various protective clothing and/or a respirator when entering the car, and testing of the oxygen levels in the car may be done before entering the car to determine what safety precautions are appropriate before entering the car (including the precaution of not entering the car at all if, e.g., the percent of oxygen is less than or equal to 19.5)

In another variation of this method, hot diesel oil (e.g., at 170° F.) is circulated within the tank using a rotary jet for a specified number of hours, and then the oil is drained back into a fuel oil pit for recirculation. Thereafter, any film and residue is washed (e.g., using a 10% soap solution [laundry detergent] or adding caustic soda [e.g., two 50 lbs. bags]), with the wash ejected or drained for recycling. The tank car is then flushed for a period of time with cold water using a rotary jet, and that is also ejected or drained for recycling. Finally, as with the previous variation, a worker inspects the car and removes any sludge, rust or scale by scrapping or brushing, and then the car interior is dried thoroughly.

According to another cleaning method which has been used, the tank car is first visually inspected to ensure that it is essentially empty but for the residue. If it is, the tank is filled to a selected level with water, and caustic soda is added. A steam hose is then inserted through, and secured in, the manway of the car and steam is pumped into the car for a selected period of time. A steam hose may also be attached to the heating coil inlet valve of the car to further assist in heating. The tank car is then flushed with cold water with a rotary jet for a selected number of hours or, if a rotary jet is not available, the tank is filled with cold water. Thereafter, if a film and residue is left on the inside of the car, it is washed with a detergent solution and water, which is then ejected or drained for recycling. Finally, a worker enters and inspects the car, removes any sludge, rust or scale by scrapping or brushing, and then the car interior is dried thoroughly.

A variety of other processes for cleaning asphalt and the like are shown in patent publications. For example, U.S. Pat. No. 3,773,303 teaches a method of cleaning an asphalt pump by reversing flow and agitating and mixing colder asphalt with the hotter material above it. U.S. Pat. No. 5,352,298 discloses an apparatus for cleaning a tank car by spraying high pressure liquid on the tank surface, and U.S. Pat. No. 5,518,553 discloses a tank cleaning apparatus and method in which the surfaces to be cleaned are blasted by water or the like. U.S. Publication No. US 2003/0209257 A1 uses a solvent spray to extract hydrocarbons from asphalt residue, and U.S. Publication No. 2004/0173247 A1 uses a sprayed mixture of water and cleaning compound with a dilution ratio appropriate to the particular asphalt contact surface being cleaned.

The present invention is directed toward improving upon the above described cleaning methods.

### SUMMARY OF THE INVENTION

In one aspect of the present invention, a method of removing residual asphalt from an asphalt transport tank car after substantially unloading the transported asphalt is provided, including the steps of (1) chilling the interior of the tank car to make the residual asphalt brittle, and (2) chipping the brittle residual asphalt from the interior of the tank car.

In one form of this aspect of the present invention, the chilling step chills the tank car to about 40° F. or below.

In another form of this aspect of the present invention, the chilling step comprises pumping cooled air into the tank. In further forms, the cooled air is about 20° F. or colder, the cooled air is pumped into the tank car until air exiting the tank car is about 20° F., and the chilling step chills the tank car to about 40° F. or below.

In still another form of this aspect of the present invention, the residual asphalt chipped from the interior of the tank car is vacuumed out.

In yet another form of this aspect of the present invention, the chipping step is accomplished using chisels and, in a further form, the chisels are pneumatic chisels.

According to another form of this aspect of the present invention, the tank car includes coils for carrying heated fluid for heating transported asphalt to help flow the asphalt for unloading, and the chilling step pumps cool fluid through the coils. In further forms, the cool fluid is about 15° F. or colder, or the tank car is chilled to about 40° F. or below. In another further form, the cool fluid is a mixture of antifreeze and water where, in still further forms, the antifreeze is ethylene glycol, and the mixture is about 25% ethylene and about 75% water.

According to still another form of this aspect of the present invention, the asphalt is non-rubberized asphalt.

According to yet another form of this aspect of the present invention, the chilling step is carried out for a length of time based on at least one of (1) the type of asphalt, and (2) the ambient temperature.

### BRIEF DESCRIPTION OF THE DRAWINGS

The figure is a partially broken away view of a railroad tank car with which the present invention may be used.

### DETAILED DESCRIPTION OF THE INVENTION

A tank car 10 such as shown in the Figure may be used to transport petroleum byproducts such as asphalt. When the tank car 10 reaches its destination, the asphalt is suitably drained or ejected to one or more other containers (not shown), such as is known.

After the tank car 10 has been essentially emptied of its asphalt load (e.g., only one inch or less of asphalt is left in the bottom of the tank car 10), the tank car may be advantageously cleaned in accordance with the present invention.

Specifically, once it has been determined that the car 10 is essentially empty, the interior of the tank car 10 is cooled to make the asphalt residue therein brittle. Generally, cooling the tank to about 40° F. will cause the residue to be sufficiently brittle, though it should be understood that still other temperatures may be appropriate depending upon, for example, the composition of the asphalt which was transported.

In accordance with one aspect of the invention, this cooling may be accomplished by inserting a cooling air hose 20 into the tank 24 of the tank car 10, as by inserting the hose 20 into the manway 30 of the car 10. As schematically illustrated (in phantom) in the Figure, the hose 20 blows cold air from a suitable air conditioner 26 for a period of time until the interior of the tank 24 is cooled sufficiently to make the asphalt residue advantageously brittle. For example, in a particularly advantageous procedure according to the present invention, the hose 20 blows cold air which is at about 20° F. or less until the outlet air vented during this process is itself about 20° F. Preferably, the outlet or vented air exits near the top of the tank 24 (e.g., up out the manway 30 around the air hose 20) to maximize cooling. Such an operation has the advantage of providing consistent feedback regarding the state of cooling in different environments, but it should be understood that rather than measure outlet air temperature to determine how long to continue cooling, a specified time period for cooling could be specified based on the environment, the asphalt composition, the initial temperature of the asphalt, and/or prior experience with this process. For example, asphalt with a low flash point (e.g., less than 350° F.) has more solvent and takes longer to harden, whereas asphalt with a high flash point (e.g., greater than 500° F.) has less solvent and hardens quicker. Further, it has been generally found that in relatively cool 50° F. ambient temperatures, sufficient air cooling (i.e., cooling the tank to about 40° F.) may be accomplished in about six hours, whereas at 75° F. to 80° F. ambient temperatures, cooling for about eight hours is required.

Alternatively, in accordance with the present invention, the tank 24 may be liquid cooled, by circulating cooled liquid through the external coils 40 arranged around the tank 24, such cooled liquid being suitably pumped into the coil inlet 44, through the coils 40, then out the coil outlet 46 for cooling and then recirculation. The Figure schematically illustrates (in phantom) one suitable arrangement which may be used, with a heat exchanger 50 which cools the liquid which is circulated via cool hose 52 and return hose 54 through the tank coils 40.

In a particularly advantageous procedure, the liquid may include an antifreeze such as ethylene glycol, such as an antifreeze mix consisting of about 25% ethylene glycol and 75% water, which liquid is cooled to about 15° F. or less. It has been generally found that in relatively cool 50° F. ambient temperatures, sufficient liquid cooling may be accomplished in about two and a half hours, whereas at 75° F. to 80° F. ambient temperatures, cooling for about three and a half hours is required to cool the tank to 40° F.

It should be understood that both air cooling and liquid cooling as described above could be simultaneously used, if desired, in which case sufficient cooling may be achieved more quickly, and the cleaning process may similarly be shortened to allow for faster return of the tank car 10 to transport service.

Once the tank has reached the desired temperature (e.g., about 40° F.), a worker may then enter the tank car 10 through the manway 30 and, using a suitable tool like a pneumatic chisel and/or chipper, chip the asphalt residue to break it up free of the walls of the tank 24, and then remove the residue chips from inside the tank 24, for example, by vacuuming, to complete cleaning. It should be appreciated, however, that chipping of the brittle asphalt residue off of the surface may also be accomplished through use of a suitable chipping machine within the broad scope of the present invention. Water and detergent cleaning or the like may then also be performed if desired.

It should be understood that the present cleaning process will work with essentially all asphalt types (except rubberized asphalt which does not harden and therefore cannot be made brittle). Different cooling times may be used depending upon the asphalt composition may be used as previously noted, but the process of the present invention may be advantageously used with any asphalt which can be made brittle by cooling.

Still other aspects, objects, and advantages of the present invention can be obtained from a study of the specification, the drawings, and the appended claims. It should be understood, however, that the present invention could be used in alternate forms where less than all of the objects and advantages of the present invention and preferred embodiment as described above would be obtained.

1. A method of removing residual asphalt from an asphalt transport tank car after substantially unloading the transported asphalt, comprising the steps of:
pumping cooling air into said tank car to chill the interior of said tank car to about 40° F. or below and make said residual asphalt brittle, wherein said pumping continues until air exiting the tank car is about 20° F.; and
chipping said brittle residual asphalt from the interior of said tank car.

2-3. (canceled)

4. The method of claim 1, wherein said cooled air is about 20° F. or colder.

5-6. (canceled)

7. The method of claim 1, further comprising the step of vacuuming out the residual asphalt chipped from the interior of said tank car.

8. The method of claim 1, wherein said chipping step is accomplished using chisels.

9. The method of claim 8, wherein said chisels are pneumatic chisels.

10-18. (canceled)

19. A method of removing residual asphalt from an asphalt transport tank car after substantially unloading the transported asphalt, comprising the steps of:
chilling the interior of said tank car to make said residual asphalt brittle by pumping cooled air into said tank until air exiting the tank car is about 20° F.; and
chipping said brittle residual asphalt from the interior of said tank car.
